(19) United States
(12) Patent Application Publication
(10) Pub. No.: US 2007/0003203 A1
(43) Pub. Date: Jan. 4, 2007

(54) Methods and apparatus for stripping optical fiber

(76) Inventor: Jeffrey D. Palmer, Ft. Worth, TX (US)

Correspondence Address: CORNING CABLE SYSTEMS LLC, P O BOX 489, HICKORY, NC, 28603, US

(21) Appl. No.: 11/171,914

(22) Filed: Jun. 30, 2005

(51) Int. Cl. G02B 6/00

(52) U.S. Cl. 385/134

(57) ABSTRACT

Apparatus includes an optical fiber connector dust cap having a body, and an optical fiber stripping blade on the body.

### BACKGROUND OF THE INVENTION

1. Field of the Invention

The present invention relates generally to optical fibers and, more particularly, to methods and apparatus for stripping optical fiber.

2. Description of the Related Art

At least one conventional method of performing a stripping operation of an optical fiber is to use a non-disposable optical fiber splitting tool. However, a non-disposable stripping tool can be expensive and, if lost, can be time consuming to replace.

### BRIEF SUMMARY OF THE INVENTION

In one aspect, apparatus is provided wherein the apparatus includes an optical fiber connector dust cap having a body, and said body contains geometry that forms an optical fiber stripping blade, or receives an optical fiber stripping blade thereon said body.

Another aspect relates to a kit including a connector assembly including a ferrule positioned at least partially within a connector housing, and a disposable optical fiber stripping blade.

In yet another aspect, an apparatus includes an optical fiber connection component, and an optical fiber stripping blade removeably attached to the component such that a user can separate the blade from the component.

In one aspect, a method of stripping at least some coating from a coated optical fiber is provided. The method includes removing a dust cap from a connector assembly, and stripping at least some coating from a coated first optical fiber using the removed dust cap.

### BRIEF DESCRIPTION OF THE DRAWINGS

FIG. 1 illustrates an exemplary connector assembly in accordance with one embodiment of the present invention.

FIG. 2 illustrates an exemplary dust cap in accordance with one embodiment of the present invention.

FIG. 3 illustrates the dust cap shown in FIG. 2.

FIG. 4 is a cut-away view of the dust cap shown in FIG. 2.

FIG. 5 is an end view of the dust cap shown in FIG. 2 including a drawing detail area “B”.

FIG. 6 illustrates an enlarged view of the detail area B shown in FIG. 5.

FIG. 7 is a cut-away view illustrating a bottom of the dust cap shown in FIG. 2.

FIG. 8 illustrates a fiber during a stripping operation.

FIG. 9 is a cross-sectional view of a portion of the blade of the dust cap shown in FIG. 2 and illustrates the blade having a straight surface.

FIG. 10 is a cross-sectional view of a portion a blade of the dust cap shown in FIG. 2 and illustrates the blade having a curved surface.

FIG. 11 is a cross-sectional view of a portion of the blade of the dust cap shown in FIG. 2 and illustrates the blade having a landing.

### DETAILED DESCRIPTION OF THE INVENTION

The present invention will now be described more fully hereinafter with reference to the accompanying drawings in which exemplary embodiments of the invention are shown. However, this invention may be embodied in many different forms and should not be construed as limited to the embodiments set forth herein. Like reference numbers refer to like elements throughout the various drawings.

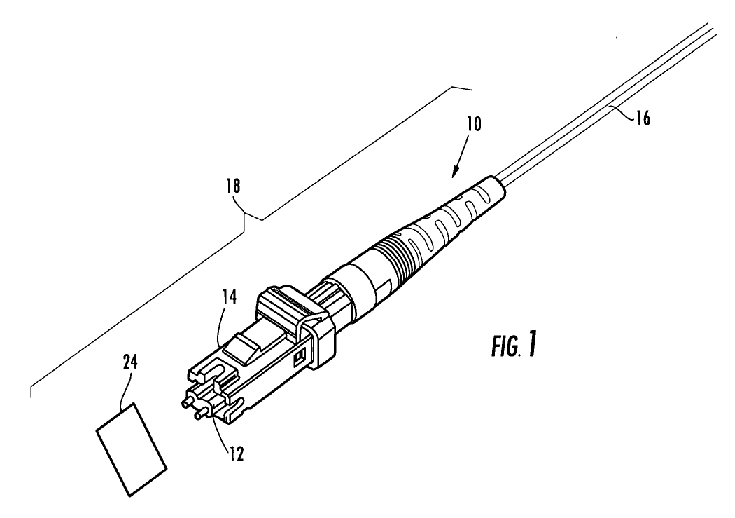

FIG. 1 illustrates an exemplary connector assembly 10 in accordance with one embodiment of the present invention. Connector assembly 10 may include a connector housing 14 and a ferrule 12 positioned at least partially within housing 14. At least one optical fiber extends from ferrule 12 though housing 14 to a non-connectorized end 16. In an exemplary embodiment, a plurality of optical fibers extend from ferrule 12 though housing 14 to non-connectorized end 16. Connector assembly 10 is shown for illustrative purposes and not for reasons of limitations. Although illustrated as an MT-RJ style connector assembly, the present inventions are applicable to all connector assemblies, such as, for example, SC, FC, ST, LC. Additionally, the benefits of the invention accrue to all optical fiber connectors including a CamSplice™ connector commercially available from Corning Cable Systems LLC of Hickory N.C., and as used herein the term “connector” refers broadly to those connectors typically termed connectors such as the SC and FC connectors and to all other optical fiber connections. Therefore, the term “connector” as used herein includes mechanical splice connectors such as the CamSplice™ assembly. In one embodiment, FIG. 1 illustrates a kit 18 including connector assembly 10 including ferrule 12 positioned at least partially within connector housing 14, and a disposable optical fiber stripping blade or geometry 24.

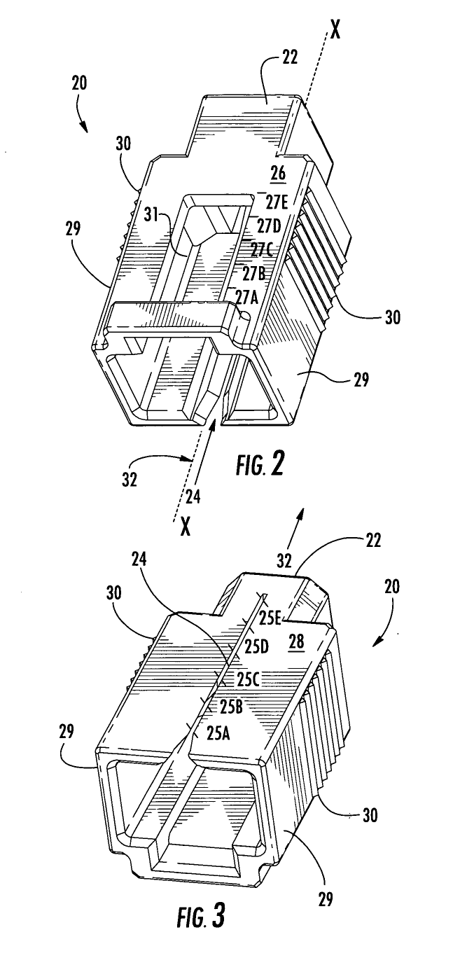

FIGS. 2 and 3 illustrate a dust cap 20 in accordance with one embodiment of the present invention. Dust cap 20 is sized to fit a housing of a connector assembly such as housing 14 of connector assembly 10. Dust cap 20 may include a body 22 and the body contains an area 24 who's geometry is shaped in a manner that it will provide the means to strip the coating of an optical fiber, hereafter referred to as a stripping blade 24. In another embodiment, body 22 is fabricated from a first material, and optical fiber stripping blade 24 is fabricated from a second material different from the first material, and blade 24 is attached to body 22. Body 22 includes a top side 26 and a bottom side 28. Top side 26 may include an opening 31. A gripping portion 30 may be provided to ease a user in the gripping of dust cap 20. In an exemplary embodiment, stripping blade 24 extends axially with a longitudinal axis 32 (X-X) on bottom side 28, however stripping blade 24 may be oblique or perpendicular with respect to axis 32 and may be on bottom side 28, top side 26, or a side 29. When positioned on a connector assembly, dust cap 20 preferably protects and covers the mating surface of the ferrule.

In use, dust cap 20 is attached to housing 14 by a manufacturer and typically sold together as a unit. The purchaser is typically an entity desiring to splice non-connectorized end 16 to an existing, or new, optical fiber in the field (herein called a “field fiber”). A craftsperson in the field removes dust cap 20 and uses optical fiber stripping blade 24 to strip a coating from either or both the fiber at non-connectorized end 16 and/or the field fiber, and then performs a splice. The splice can be a fusion splice or a mechanical connection such as shown in U.S. Pat. No. 6,379,054, which is herein incorporated in its entirety by reference. After the splicing, connector housing 14 is inserted to a receptacle (not shown) and ferrule 12 is positioned to mate with another ferrule thus providing the field fiber with a connection to a service. More specifically, each ferrule includes a mating face and the mating faces are positioned to preferably contact each other. Although described in the context of a field fiber, the described herein methods and apparatus can be used in a factory setting also, and the field fiber description is meant to be illustrative and not as a limitation. Additionally, although illustrated with a fiber extending through the ferrule to a non-connectorized end, some embodiments have no fiber in the ferrule or have a stub fiber in the ferrule. In the case of no fiber, the craftsperson typically epoxies the fiber in place and performs a polishing operation in the field or in a factory. The ferrule may be a single fiber ferrule in which case the dust cap is a single fiber dust cap or the ferrule may be a multiple fiber ferrule as shown in FIG. 1 in which case the dust cap can be a multiple fiber dust cap. In an exemplary embodiment, at least one optical fiber extends from the ferrule though the housing to a non-connectorized end. In another exemplary embodiment, a stub fiber is positioned within the ferrule. In another embodiment, no fiber is in the ferrule until a user strips a fiber with dust cap 20 and inserts the fiber into the ferrule.

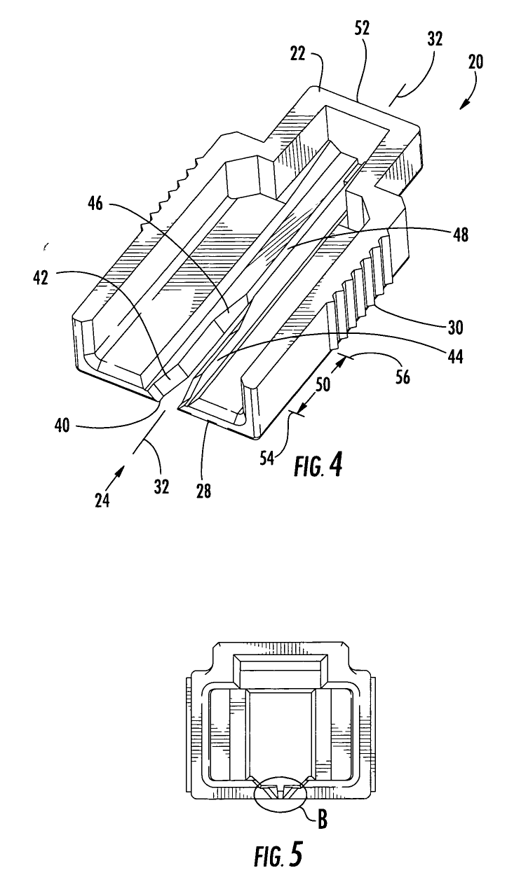

FIG. 4 is a cut-away perspective view of dust cap 20. Stripping blade 24 includes an entry portion 40 extending substantially axially, and a chamfered guide opening 42 extending inward toward axis 32 to guide an optical fiber toward a first stripping portion 44 and a second stripping portion 46. First stripping portion 44 and second stripping portion 46 together form a stripping zone 50 sufficient to strip a plurality of different fibers at different locations, see, for example, FIG. 3 for locations 25a, 25b, 25c, 25d, and 25d for a five location embodiment.

In a further exemplary embodiment, the material of stripping blade 24 has a hardness that is relatively less than the hardness of the glass fiber such that blade 24 is deformable in that blade 24 will remove a coating on an optical fiber but will not damage the optical fiber. Rather, upon contact with the glass cladding of the optical fiber, blade 24 can deform. In one embodiment, the deformation is a plastic deformation in that the deformed portion of the blade does not totally spring back upon removal of the optical fiber. In another embodiment, the deformation is minimized and is elastic.

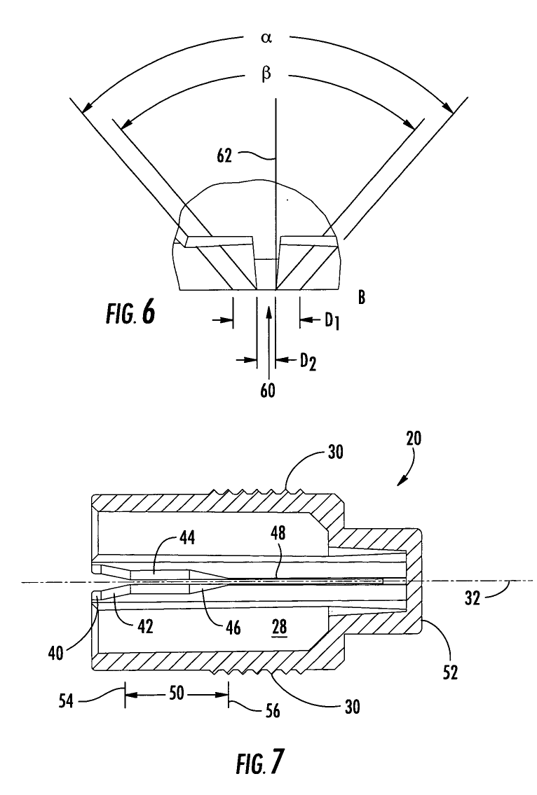

To further illustrate the plastic deformation embodiment, when a first optical fiber is stripped, a portion of the stripping surface adjacent chamfered guide opening 42 (such as portion 25a in FIG. 3) is deformed. When a second optical fiber is stripped, a different portion of the stripping surface further back from the chamfered portion 42 (such as portion 25b in FIG. 3) is used and deforms. In that regard, the craftsperson can align the fiber with portions 25a and 27a and perform a stripping operation, then align another fiber with 25b and 27b to perform a second stripping operation, and so forth. Returning to FIG. 4, this movement from a front end 54 towards a back end 56 of zone 50 of the stripping surface continues until most or all of the stripping surface is deformed. In this respect, dust cap 20 may be disposable in that dust cap 20 is designed to provide a certain number of stripping operations and then be disposed of. In an exemplary embodiment, stripping zone 50 is selected to provide, for example, from five to twenty stripping operations. In other embodiments, stripping zone 50 provides for a number of stripping operations other than from five to twenty. In the case of a multiple fiber dust cap, one embodiment provides for the same number of stripping operations as the number of fibers. For example with a ferrule including twelve fibers, stripping zone 50 allows for at least twelve stripping operations. A channel 48 extends from the stripping surface towards a back wall 52. Channel 48 allows dust cap 20 to flex inward toward axis 32 thereby narrowing gap 60 (FIG. 6) to a dimension less than 250 microns. In one embodiment, a tool that provides a mechanical advantage is used to allow a person to apply more force to close gap 60 than the person could apply without the tool. In other words, while one embodiment utilizes a geometry and/or material such that a person can manually apply sufficient force to cause gap 60 to close about a coated optical fiber, in another embodiment, a typical user can not apply sufficient force and a tool is useful to provide a mechanical advantage. In another tool-less embodiment, gap 60 is sized smaller that the diameter of the glass cladding and, just by inserting a optical fiber into gap 60, some coating is removed.

Additionally, stripping blade 24 may be associated with a connector and not necessary on a dust cap. For example, in one embodiment, a kit is provided wherein the kit includes a connector assembly including a ferrule positioned at least partially within a connector housing. The kit also includes a disposable optical fiber stripping blade. The stripping blade may be on a dust cap wherein the dust cap is a dual purpose device in that it is configured to protect the ferrule from dust and to strip an optical fiber. Alternatively, the stripping blade may be a one-purpose device dedicated to the stripping of optical fibers, or it could be a dual purpose device with a second purpose other than as a dust cap, for example, but not limited to a crimping tool. Another example of a dual purpose device is a container such as the packaging for a connector. Other examples include holders and carriers. Additionally, the stripping blade may be a user removable part of any connection component. For example, in one embodiment, a stripping blade is molded to housing 14 such that a user can snap off or otherwise remove the stripping blade from housing 14 or any other surface on any optical fiber connection component, such as, for example, but not limited to, a optical fiber connection crimp tool or another tool. One example of another tool would be a tool that holds dust cap 20 and allows for an alignment between dust cap 20 and the fiber to be stripped. As used herein, the phrase “optical fiber connection component” refers to any component utilized in a connection either as part of the connection or any device used to facilitate making the connection. The phrase “optical fiber connection component” also refers to the packaging used to contain any component utilized in the connection either as part of the connection or any device used to facilitate making the connection.

In use with regards to the kit embodiment, an installer (i.e., the craftperson) opens the kit and removes the connector assembly and the stripping blade. The installer then uses the stripping blade to strip a coating from a fiber such as the fiber at the non-connectorized end of the connector assembly and/or the field fiber. After use, the stripping blade can either be disposed of or retained for additional stripping operations if desired. In one embodiment, the disposable stripping blade is insertable into a tool that positions the fiber to be stripped within gap 60 (FIG. 6). The tool also holds the fiber and provides a force on the blade to narrow gap 60 to a smaller size than 250 microns to effectuate the stripping action.

FIG. 5 is an end view of dust cap 20 identifying a detail area “B”. FIG. 6 illustrates detail area B wherein a gap 60 formed by stripping blade 24 is a dimension “D1” wide at first entry portion 40 and chamfers down to a dimension “D2” within the stripping section. All portions 40, 42, 44, and 46 have angled surfaces that are angles α or β with centers centered about a perpendicular 62. In one embodiment, α and β are equal and are both 80 degree angles. In another embodiment, angles α and β may be unequal and may vary from about 45 degrees to about 130 degrees. In one embodiment, D1 is about 900 microns and D2 is about 250 microns. In other embodiments, D1 ranges from 500 to 1500 microns and D2 ranges from 100 to 400 microns. FIG. 7 is a cut-away view illustrating bottom 28 of dust cap 20.

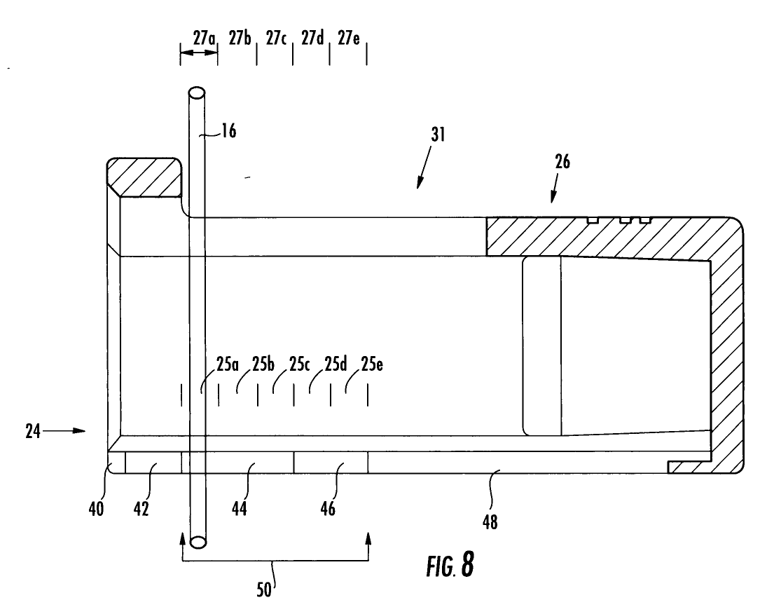

FIG. 8 illustrates fiber 16 during a stripping operation. Prior to the view shown in FIG. 8, and with regard to an embodiment where D2 is less than the diameter of fiber 16, fiber 16 may be inserted at an angle such that fiber 16 passes through opening 31 at stripping section 27a with out contacting stripping blade 24, then fiber 16 is rotated to be normal to top surface 26 and the bottom of fiber 16 enters entry portion 40 and then is guided by chamfered guide opening 42 to first stripping portion 25a of blade 24. Upon fiber 16 contacting first stripping portion 25a, first stripping portion 25a deforms (not shown). In another embodiment, D2 is greater than the diameter of fiber 16, and is inserted into gap 60 from the bottom of FIG. 8. The craftsperson then narrows gap 60 by compressing the sides of cap 20 either with or without a tool. In both embodiments, after fiber 16 is positioned as shown in FIG. 8, the craftsperson pulls fiber 16 in an upward direction (only with respect to FIG. 8, it should be noted that the stripping operation may be done in any orientation) to strip the coating (not shown) from fiber 16.

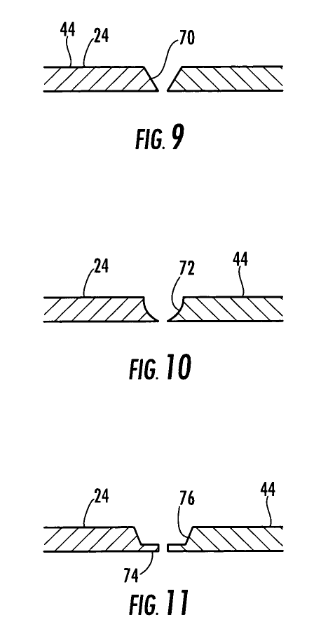

FIG. 9 is a cross-sectional view of portion 44 and illustrates blade 24 having a straight surface 70. FIG. 10 is a cross-sectional view of portion 44 and illustrates blade 24 having a curved surface 72. FIG. 11 is a cross-sectional view of portion 44 and illustrates blade 24 having a landing 74. The differences in blade shapes shown in FIGS. 9-11 can be selectively chosen based upon material type and desired deformation characteristics. In some embodiments, all portions 40, 42, 44, and 46 have the same blade shape. In other embodiments, different portions 40, 42, 44, and 46 may have different shapes.

Accordingly, there are herein provided methods and apparatus that allow for easy and cost effective fiber stripping operations. Additionally, by including a disposable optical fiber stripping blade with a connector kit, convenience to the installer is increased. In the embodiment with a dust cap, the dust cap can be a single fiber dust cap for a single fiber connector or a multiple fiber dust cap for a multiple fiber connector.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

That which is claimed is:

1. Apparatus comprising:
an optical fiber connection component; and
an optical fiber stripping blade removeably attached to said component such that a user can separate said blade from said component.

2. Apparatus in accordance with claim 1 wherein said component comprises a connector housing.

3. Apparatus in accordance with claim 1 wherein said component comprises a tool.

4. Apparatus in accordance with claim 3 wherein said component comprises a crimp tool.

5. Apparatus comprising:
an optical fiber connector dust cap comprising a body; and
an optical fiber stripping blade on said body.

6. Apparatus in accordance with claim 5 wherein said optical fiber stripping blade is deformable such that said blade removes a coating on an optical fiber but does not damage the optical fiber.

7. Apparatus in accordance with claim 5 wherein said optical fiber stripping blade is fabricated from a first material and said body is fabricated from a second material different from the first material.

8. Apparatus in accordance with claim 5 wherein said optical fiber stripping blade and said body are fabricated from a first material.

9. Apparatus in accordance with claim 5 wherein said optical fiber connector dust cap comprises a multiple fiber dust cap.

10. Apparatus in accordance with claim 5 wherein said optical fiber connector dust cap comprises a single fiber dust cap.

11. Apparatus in accordance with claim 5 wherein said optical fiber stripping blade positioned on a bottom side of said body.

11. A kit comprising:
a connector assembly comprising a ferrule positioned at least partially within a connector housing, and
a disposable optical fiber stripping blade.

12. A kit in accordance with claim 11 further comprising a dust cap, when said disposable optical fiber stripping blade positioned on said dust cap.

13. A kit in accordance with claim 12 wherein said dust cap is attached to said housing and covers a mating face of said ferrule.

14. A kit in accordance with claim 12 wherein said dust cap comprises a body fabricated from a first material, and wherein said optical fiber stripping blade is fabricated from a second material different than said first material.

15. A kit in accordance with claim 13 wherein said optical fiber stripping blade comprises a stripping surface of sufficient length to strip a plurality of fibers each at a different location along the stripping surface.

16. A kit in accordance with claim 14 wherein said optical fiber stripping blade is deformable such that said blade removes a coating on an optical fiber but does not damage the optical fiber.

17. A kit in accordance with claim 15 wherein said optical fiber connector dust cap comprises a multiple fiber dust cap.

18. A method of stripping at least some coating from a coated optical fiber, said method comprising:
removing a dust cap from a connector assembly; and
stripping at least some coating from a coated first optical fiber using the removed dust cap.

19. A method in accordance with claim 18 further comprising stripping at least some coating from a coated second optical fiber using the removed dust cap.

20. A method in accordance with claim 18 further comprising:
placing the stripped fiber in side a ferrule of the connector assembly; and
placing the dust cap on the connector assembly.
